(19) United States
(12) Patent Application Publication
(10) Pub. No.: US 2024/0202288 A1
(43) Pub. Date: Jun. 20, 2024

(54) METHOD FOR MANAGING LICENSE OF THIRD-PARTY APPLICATION AND CLOUD SERVER FOR EXECUTING THE SAME

(71) Applicant: CLOUDIKE INC., Gyeonggi-do (KR)

(72) Inventor: Sun Ung LEE, Seoul (KR)

(21) Appl. No.: 18/205,622

(22) Filed: Jun. 5, 2023

(30) Foreign Application Priority Data
Dec. 15, 2022 (KR) 10-2022-0175528

(51) Int. Cl. G06F 21/10

(52) U.S. Cl. CPC G06F 21/105

(57) ABSTRACT

In a method for managing license of third-party application, a limited number of licenses can be more efficiently distributed and managed by automatically switching an operation mode of a local terminal, which is currently connected to a third-party application in a first operation mode, but is determined not to be currently using the third-party application because there is no input or file change through the first operation mode, from the first operation mode to the second operation mode.

### CROSS-REFERENCE TO RELATED APPLICATION AND CLAIM OF PRIORITY

This application claims the benefit under 35 USC § 119 of Korean Patent Application No. 10-2022-0175528 filed on Dec. 15, 2022, in the Korean Intellectual Property Office, the entire disclosure of which is incorporated herein by reference for all purposes.

### BACKGROUND

The present disclosure relates to a technology for managing a license of a third-party application.

With the development of network technology, data that used to be stored in a terminal (e.g., a desktop, laptop, portable device, etc.) used by a user may be stored in a cloud storage, and the user may use the data stored in the cloud storage anytime, anywhere by using his/her account whenever he or she needs the data. The user can upload or download a file through the cloud storage, and check a modified file in real time through file sharing and synchronization.

In addition, recently, the cloud storage provides more diverse functions and services in conjunction with various third-party applications. As an example, the user may use various third-party applications such as a web office, such as OFFICE 365, ONLYOFFICE, etc., a software development tool, an image editing tool, etc. while connected to the cloud storage, and may more easily check or edit files stored in the cloud storage through these third-party applications.

On the other hand, in order to use these third-party applications on the cloud storage, a cloud service provider should purchase licenses for the third-party applications in large quantities in advance. However, from the point of view of the cloud service provider, it is difficult to determine the number of licenses to be purchased and to efficiently and flexibly manage the licenses in a state where a limited number of licenses are purchased.

### SUMMARY

The present disclosure provides a method for managing a license of a third-party application and a cloud server for executing the same for efficiently distributing and managing, in a state where a set number of licenses of the third-party application have been purchased, the licenses based on a connection status of the third-party application through the licenses.

In accordance with an exemplary embodiment of the present disclosure, a cloud server includes a monitoring unit configured to monitor, in a state where a set number of licenses for a first operation mode of a third-party application are purchased from a third-party application server, a connection status in which connection to the third-party application is made in the first operation mode through the licenses of local terminals connected to the cloud storage in real time, and a mode switching unit configured to determine a local terminal not currently using the first operation mode among local terminals connected to the third-party application in the first operation mode and switch the first operation mode to a second operation mode in which a range of use rights of the third-party application is reduced compared to the first operation mode for a local terminal of which the time of not using the first operation mode exceeds a threshold value among the local terminals determined not to be using the first operation mode.

The time of not using the first operation mode may be a duration during which no input or file change is made on the third-party application from a time point of logging in to the first operation mode in the local terminal or a time point of refreshing a screen of the first operation mode in the local terminal.

The mode switching unit, when a plurality of local terminals of which the time of not using the first operation mode exceeds the threshold value are present among the local terminals determined not to be using the first operation mode, may be configured to assign a priority to each of the plurality of local terminals in consideration of at least one of user's affiliation information corresponding to the local terminal, a non-input duration of the local terminal in the first operation mode, and a usage pattern for the first operation mode of the local terminal during a set time in the past, and sequentially perform switching to the second operation mode for each of the plurality of local terminals according to the priority.

The mode switching unit may be configured to distribute the set number of licenses to local terminals that do not have use rights of the first operation mode free of charge when the number of local terminals connected in the first operation mode through the license is equal to or less than a first reference value, and preferentially switch the first operation mode to the second operation mode for the local terminals to which the license is distributed free of charge when the number of local terminals connected in the first operation mode through the license exceeds a second reference value.

The cloud server may further include a pattern learning unit configured to learn a connection pattern of local terminals for the first operation mode for a set period from a connection status in which connection to the third-party application is made in the first operation mode through the license, an information collection unit configured to collect the number of new subscribers of the cloud storage and affiliation information of the new subscribers, and a license management unit configured to predict, as a result of an analysis of the connection pattern, the maximum number of simultaneous connections of the local terminals for the first operation mode for a set period in the future and a time point exceeding a reference value at which it is determined that the maximum number of simultaneous connections exceeds a set third reference value, based on the number of new subscribers and the affiliation information of the new subscribers, and calculate an additional purchase time point and the number of additional purchases of the licenses for the first operation mode based on the predicted maximum number of simultaneous connections and the time point exceeding the reference value.

The license management unit may be configured to select information on the connection pattern of local terminals corresponding to the affiliation information of the new subscriber among pieces of information on the connection pattern learned by the pattern learning unit, and predict, using the selected information on the connection pattern and the number of new subscribers, the maximum number of simultaneous connections of the local terminals for the first operation mode for a set period in the future and the time point exceeding a reference value at which it is determined that the maximum number of simultaneous connections exceeds the set third reference value.

In accordance with an exemplary embodiment of the present disclosure, a method for managing a license of a third-party application performed in a cloud server for which a set number of licenses for a first operation mode of the third-party application are purchased from a third-party application server, the method including monitoring, by a monitoring unit, a connection status in which connection to the third-party application is made in the first operation mode through the licenses of local terminals connected to the cloud storage in real time, determining, by a mode switching unit, a local terminal not currently using the first operation mode among local terminals connected to the third-party application in the first operation mode, and switching, by the mode switching unit, the first operation mode to a second operation mode in which a range of use rights of the third-party application is reduced compared to the first operation mode for a local terminal of which the time of not using the first operation mode exceeds a threshold value among the local terminals determined not to be using the first operation mode.

The time of not using the first operation mode may be a duration during which no input or file change is made on the third-party application from a time point of logging in to the first operation mode in the local terminal or a time point of refreshing a screen of the first operation mode in the local terminal.

In the switching of the first operation mode to the second operation mode, when a plurality of local terminals of which the time of not using the first operation mode exceeds the threshold value are present among the local terminals determined not to be using the first operation mode, a priority may be assigned to each of the plurality of local terminals in consideration of at least one of user's affiliation information corresponding to the local terminal, a non-input duration of the local terminal in the first operation mode, and a usage pattern for the first operation mode of the local terminal during a set time in the past, and switching to the second operation mode may be sequentially performed for each of the plurality of local terminals according to the priority.

The method for managing the license of the third-party application may further include, after the monitoring of the connection status in which connection to the third-party application is made in the first operation mode in real time, distributing, by the mode switching unit, the set number of licenses to local terminals that do not have use rights of the first operation mode free of charge when the number of local terminals connected in the first operation mode through the license is equal to or less than a first reference value, and preferentially switching, by the mode switching unit, the first operation mode to the second operation mode for the local terminals to which the license is distributed free of charge when the number of local terminals connected in the first operation mode through the license exceeds a second reference value.

The method for managing the license of the third-party application may further include, after the monitoring of the connection status in which connection to the third-party application is made in the first operation mode in real time, learning, by a pattern learning unit, a connection pattern of local terminals for the first operation mode for a set period from the connection status in which connection to the third-party application is made in the first operation mode through the license, collecting, by an information collection unit, the number of new subscribers of the cloud storage and affiliation information of the new subscribers, predicting, by a license management unit, as a result of an analysis of the connection pattern, the maximum number of simultaneous connections of local terminals for the first operation mode for a set period in the future and a time point exceeding a reference value at which it is determined that the maximum number of simultaneous connections exceeds a set third reference value, based on the number of new subscribers and the affiliation information of the new subscribers, and calculating, by the license management unit, an additional purchase time point and the number of additional purchases of the licenses for the first operation based on the predicted maximum number of simultaneous connections and the time point exceeding the reference value.

In the predicting of the time point exceeding the reference value, information on the connection pattern of local terminals corresponding to the affiliation information of the new subscriber may be selected among pieces of information on the connection pattern learned by the pattern learning unit, and the maximum number of simultaneous connections of local terminals for the first operation mode for a set period in the future and the time point exceeding a reference value at which it is determined that the maximum number of simultaneous connections exceeds the set third reference value may be predicted using the selected information on the connection pattern and the number of new subscribers.

### BRIEF DESCRIPTION OF THE DRAWINGS

Exemplary embodiments can be understood in more detail from the following description taken in conjunction with the accompanying drawings, in which:

FIG. 1 is a schematic diagram of a system for managing a license of a third-party application in accordance with exemplary embodiment of the present disclosure:

FIG. 2 is a block diagram illustrating a detailed configuration of a cloud server in accordance with the exemplary embodiment of the present disclosure:

FIG. 3 is a diagram illustrating an example of a first operation mode and a second operation mode in accordance with the exemplary embodiment of the present disclosure:

FIG. 4 is a diagram illustrating an example of a user interface for switching between the first operation mode and the second operation mode in accordance with the exemplary embodiment of the present disclosure:

FIG. 5 is a table illustrating an example of a connection status in which connection to the third-party application is made in the first operation mode in accordance with the exemplary embodiment of the present disclosure:

FIG. 6 is a flowchart for describing a method of switching an operation mode of a third-party application in accordance with the exemplary embodiment of the present disclosure;

FIG. 7 is a flowchart for describing a method of predicting a time point of additional purchase and the number of additional purchases of licenses in accordance with the exemplary embodiment of the present disclosure; and

FIG. 8 is a block diagram for illustratively describing a computing environment including a computing device suitable for use in exemplary embodiments.

### DETAILED DESCRIPTION OF EMBODIMENTS

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. In addition, terms to be described later are terms defined in consideration of functions in the present disclosure, which may vary according to the intention or custom of users or operators. Therefore, the definition thereof should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

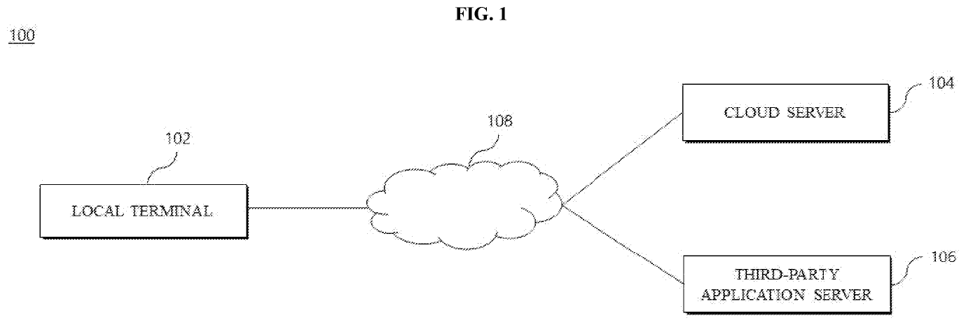

FIG. 1 is a schematic diagram of a system 100 for managing a license for a third-party application in accordance with exemplary embodiment of the present disclosure. As illustrated in FIG. 1, the system 100 for managing the license of the third-party application according to an embodiment of the present disclosure includes a local terminal 102, a cloud server 104, a third-party application server 106, and a network 108. The local terminal 102, the cloud server 104, and the third-party application server 106 may be connected to each other via the network 108. Here, the network 108 may include, for example, a mobile network such as the Internet, a Wi-Fi network, a 3G network, an LTE network, etc., and wide area networks, etc.

The local terminal 102 is a terminal possessed by a user and may include, for example, a desktop computer, a laptop computer, a tablet computer, a smart phone, a PDA, or a wearable device such as a smart watch. The user may access a cloud storage (not illustrated) provided by the cloud server 104 through the local terminal 102. The user may upload or download a file through a cloud storage, and check a modified file in real time through file sharing and synchronization. Here, the file may include, for example, a document, a picture, an image, a video file, etc., but the type of the file is not particularly limited. In addition, as will be described later, the user may use a third-party application provided by the third-party application server 106 while connected to the cloud storage.

The cloud server 104 is an apparatus that manages the cloud storage and provides various cloud services through the cloud storage. In these embodiments, the cloud storage is a repository where the file is stored. The user can connect to the cloud storage through the local terminal 102 and perform file access, file modification, file generation, file upload, file download, etc.

In addition, the cloud server 104 may provide various functions and services to the user through the third-party application in conjunction with the third-party application server 106. In these embodiments, the third-party application is an application provided by the third-party application server 106 rather than the application provided by the cloud provider's server, that is, the cloud server 104, and may be, for example, a web office such as OFFICE 365, ONLYOFFICE, etc., a software development tool, an image editing tool, etc. These third-party applications may operate in a plurality of operation modes, and a range of use rights of the third-party application may vary according to each operation mode.

As an example, a first operation mode of the third-party application may be an editing mode, and a second operation mode of the third-party application may be a reading mode. The second operation mode is a mode in which the range of use rights of the third-party application is reduced compared to the first operation mode, and accordingly, the user cannot use some functions of the third-party application in the second operation mode. The user can use the second operation mode free of charge, but should pay a predetermined amount for the second operation mode. As such, the first operation mode and the second operation mode are different in the range of use rights of the third-party application. In order for the local terminals 102 to access to the first operation mode, the cloud server 104 may purchase a set number of licenses for the first operation mode from a provider of the third-party application. The license for the first operation mode means a right to use the third-party application in the first operation mode. Meanwhile, here, for convenience of explanation, the operation mode of the third-party application has been described by dividing into two operation modes, the first operation mode and the second operation mode, but is not limited thereto. For the third-party application, three or more operation modes with different ranges of use rights may be provided.

The third party application server 106 is a server of a provider that provides the third-party application. The third-party application server 106 may provide the third-party application to the local terminal 102 in conjunction with the cloud server 104. As described above, the user may use the third-party application provided by the third-party application server 106 while connected to the cloud storage.

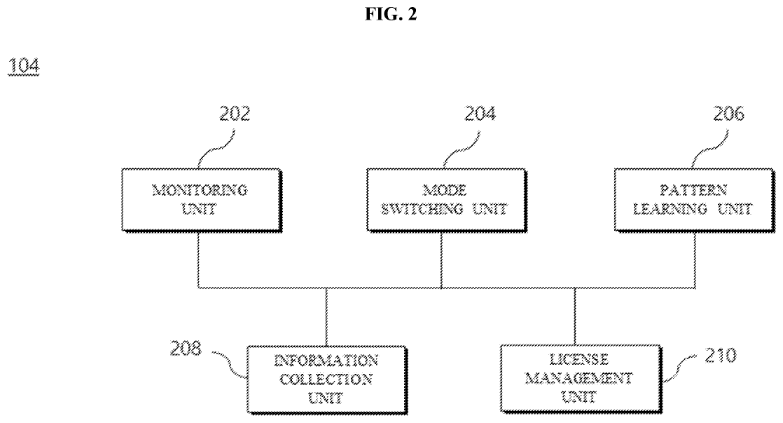

In this case, the cloud server 104 may purchase a set number of licenses for the first operation mode of the third-party application in consideration of the total number of users (or subscribers) of the cloud storage. For example, if the total number of users (or subscribers) of the cloud storage is 1,000 people, the cloud server 104 may purchase about 800 licenses for the first operation mode of the third-party application from the third-party application server 106. However, the users (or subscribers) of the cloud storage have different usage patterns for the first operation mode of the third-party application for each affiliated company/team or individual. Therefore, from the standpoint of the cloud provider, it is not only difficult to determine the number of the licenses to be purchased, but also difficult to efficiently and flexibly manage the licenses in a state where a limited number of licenses are purchased. Therefore, in the present disclosure, the cloud server 104 monitors in real time a connection status in which connection to the third-party application is made in the first operation mode through the license of the local terminals 102 connected to the cloud storage in a state in which the cloud server 102 purchases a set number of licenses for the first operation mode of the third-party application from the third-party application server 106, and then, efficiently manages the licenses based on this. Hereinafter, a management configuration of such a license will be described in more detail with reference to FIGS. 2 to 6.

FIG. 2 is a block diagram illustrating a detailed configuration of a cloud server in accordance with the exemplary embodiment of the present disclosure. As illustrated in FIG. 2, the cloud server 104 according to an embodiment of the present disclosure includes a monitoring unit 202, a mode switching unit 204, a pattern learning unit 206, an information collection unit 208, and a license management unit 210.

The monitoring unit 202 monitors, in a state where a set number of licenses for the first operation mode of the third-party application are purchased from the third-party application server 106, the connection status in which connection to the third-party application is made in the first operation mode through the licenses of local terminals connected to the cloud storage in real time. Here, the first operation mode is an operation mode that has a wider range of use rights of the third-party application than the second operation mode, which will be described later, and may be, for example, an editing mode of the web office. The monitoring unit 202 may collect information on one or more local terminals 102 currently logged into the third-party application in the first operation mode among the local terminals 102 connected to the cloud storage. The monitoring unit 202 may collect, for example, identification information of the local terminal 102 currently logged into the web office in the editing mode of the web office among the local terminals 102 connected to the cloud storage, user's affiliation information corresponding to the local terminal 102, the connection time of the third-party application through the first operation mode of the local terminal 102, etc. Here, the user's affiliation information may be, for example, affiliation such as a company, team, or department to which the user belongs, a job, a position, etc.

The mode switching unit 204 switches the operation mode of one or more local terminals 102 among the local terminals 102 logged into the third-party application in the first operation mode into the second operation mode according to a monitoring result of the monitoring unit 202. Here, the second operation mode is an operation mode in which the range of use rights of the third-party application is reduced compared to the first operation, and may be, for example, the reading mode of the web office.

Specifically, the mode switching unit 204 determines the local terminal 102 that is not currently using the first operation mode among the local terminals 102 connected to the third-party application in the first operation mode, and switches the first operation mode into the second operation mode for the local terminal 102 of which the time of not using the first operation mode exceeds a threshold value among the local terminals 102 determined not to be using the first operation mode. As an example, the mode switching unit 204 may select the local terminals 102 by which no input or file change is currently being made on the third-party application among the local terminals 102 connected to the third-party application in the first operation mode, and switch the first operation mode to the second operation mode for the local terminal 102 of which the time of not using the first operation mode exceeds a threshold value (e.g., 30 minutes) among the selected local terminals 102. Here, the time of not using the first operation mode may be a duration during which no input or file change is made on the third-party application from a time point of logging in to the first operation mode in the local terminal 102 or a time point of refreshing a screen of the first operation mode in the local terminal 102. For example, the mode switching unit 204 may select the local terminals 102 of #1, #4, #5, and #7 in which no input or file change is currently being made on the third-party application among the local terminals 102 connected to the third-party application in the first operation mode, and switch the first operation mode to the second operation mode for the local terminals 102 of #1 and #4 of which the time of not using the first operation mode exceeds a threshold value (e.g., 30 minutes) among the selected local terminals 102 of #1, #4, #5, and #7.

In this case, the mode switching unit 204 may automatically store a file being in the last input state in the local terminal 102 before switching the operation mode of the local terminal 102 from the first operation mode to the second operation mode. In addition, the mode switching unit 204 may transmit a notification message for switching operation mode to the local terminal 102 before switching the operation mode of the local terminal 102 from the first operation mode to the second operation mode.

As described above, according to embodiments of the present disclosure, a limited number of licenses can be more efficiently distributed and managed by automatically switching the operation mode of the local terminal 102, which is currently connected to the third-party application in the first operation mode, but is determined not to be currently using the third-party application because there is no input or file change through the first operation mode, from the first operation mode to the second operation mode.

In addition, the mode switching unit 204, when a plurality of local terminals of which the time of not using the first operation mode exceeds the threshold value are present among the local terminals 102 determined not to be using the first operation mode, may assign a priority to each of the plurality of local terminals in consideration of at least one of user's affiliation information corresponding to the local terminal 102, a non-input duration of the local terminal 102 in the first operation mode, and a usage pattern for the first operation mode of the local terminal 102 during a set time in the past, and then sequentially perform switching to the second operation mode for each of the plurality of local terminals according to the priority.

As an example, the mode switching unit 204 may assign a higher priority to the local terminal 102 having set affiliation information (e.g., company A's accounting team among the plurality of local terminals 102 than other local terminals 102. In this case, the mode switching unit 204 may preferentially switch the operation mode from the first operation mode to the second operation mode for the local terminal 102 having the set affiliation information (e.g., company A's accounting team).

As another example, the mode switching unit 204 may assign a higher priority to the local terminal 102 as a non-input duration in the first operation mode is longer among the plurality of local terminals 102. In this case, the mode switching unit 204 may preferentially switch the operation mode from the first operation mode to the second operation mode for the local terminal 102 having the longest non-input duration.

As still another example, the mode switching unit 204, as a result of an analysis of a usage pattern for each of the plurality of local terminals 102, when a switching history from the first operation mode to the second operation mode in the time zone corresponding to the current time zone of the local terminal 102 is equal to or greater than the set number of times, when the number of connection times for the first operation mode of the local terminal 102 is less than the set number of times, or when other local terminals 102 within the affiliated company are already connected thereto in the first operation mode and using the first operation mode in excess of the set number, may give the local terminals 102 within the affiliated company a higher priority than other local terminals 102 within the affiliated company. The mode switching unit 204 may preferentially switch the operation mode from the first operation mode to the second operation mode for the local terminal 102 to which high priority is given in this way. The mode switching unit 204 may assign the priority to each of the plurality of local terminals 102 by combining user's affiliation information corresponding to the local terminal 102, a non-input duration of the local terminal 102 in the first operation mode, and a usage pattern for the first operation mode of the local terminal 102 during a set time in the past, and then sequentially perform switching to the second operation mode for each of the plurality of local terminals according to the priority.

That is, according to embodiments of the present disclosure, the priority may be assigned to each of the plurality of local terminals 102 in consideration of at least one of user's affiliation information corresponding to the local terminal 102, a non-input duration of the local terminal 102 in the first operation mode, and a usage pattern for the first operation mode of the local terminal 102 during a set time in the past, and local terminals 102 that urgently need to switch from the first operation mode to the second operation mode can be sequentially switched to the second operation mode first according to the priority. The switching from the first operation mode to the second operation mode is necessary for various reasons, such as the total number of licenses purchased from the third-party application server 106, license fees, and system load of the cloud storage. Accordingly, in the present disclosure, when a plurality of local terminals 102 determined not to be currently using the first operation mode are present, the operation mode of each local terminal 102 can be sequentially switched from the first operation mode to the second operation mode according to the priority.

In addition, the mode switching unit 204 may distribute the set number of licenses to the local terminals 102 that do not have the use rights of the first operation mode free of charge when the number of the local terminals 102 connected in the first operation mode through the license is equal to or less than a first reference value. As an example, when the number of local terminals 102 connected in the first operation mode through the licenses is approximately 100 or less, the mode switching unit 204 may distribute approximately 100 licenses among the pre-purchased licenses to the local terminals 102 that do not have the use rights of the first operation mode free of charge.

After that, when the number of local terminals 102 connected in the first operation mode through the licenses exceeds a second reference value, the mode switching unit 204 may preferentially switch the first operation mode to the second operation mode for the local terminals 102 to which the licenses are distributed free of charge. As an example, when the number of local terminals 102 connected in the first operation mode through the licenses exceeds 250, the mode switching unit 204 may preferentially switch the first operation mode to the second operation mode for the local terminals 102 to which the licenses are distributed free of charge. As such, according to embodiments of the present disclosure, service promotion and license management can be performed simultaneously by distributing the purchased licenses to the local terminals 102 that do not have the use rights of the first operation mode free of charge when a use amount using the first operation mode is small compared to the number of purchased licenses and preferentially switching the operation mode of the local terminals 102 to which the licenses are distributed free of charge from the first operation mode to the second operation mode when the need to limit the use of the license arises due to the increase in the use amount using the first operation mode.

The pattern learning unit 206 learns a connection pattern of the local terminals 102 for the first operation mode for a set period from a connection status to the first operation mode (i.e., connection status in which connection to the third-party application is made in the first operation mode) in the monitoring unit 202. As mentioned above, the monitoring unit 202 may collect, for example, identification information of the local terminal 102 currently logged into the web office in the editing mode of the web office among the local terminals 102 connected to the cloud storage, user's affiliation information corresponding to the local terminal 102, the connection time of the third-party application through the first operation mode of the local terminal 102, etc.

As an example, the pattern learning unit 206 may learn connection patterns for the local terminals 102 by analyzing identification information of the local terminals 102 connected to the third-party application through the first operation mode for the last 5 months, user's affiliation information of corresponding to the local terminals 102, and the connection time of the third-party application through the first operation mode of the local terminals 102, etc. In this case, the pattern learning unit 206 may learn the connection pattern for each local terminal 102 for each user's affiliation information corresponding to the local terminal 102 and connection time zone.

The information collection unit 208 may collect the number of new subscribers of the cloud storage and affiliation information of the new subscribers. The information collection unit 208 may collect information on new subscriber status of the cloud storage from the last time the license for the first operation mode was purchased to the present. As an example, the information collection unit 208 may collect the number of new subscribers (e.g., approximately 10 people) of the cloud storage from the last time the license for the first operation mode was purchased to the present and affiliation information (e.g., Company #1/development team approximately 5 people, Company #1/human resources team approximately 5 people) of the new subscribers.

The license management unit 210 predicts, as a result of an analysis of the connection pattern, the maximum number of simultaneous connections of the local terminals 102 for the first operation mode for a set period in the future and a time point exceeding a reference value at which it is determined that the maximum number of simultaneous connections exceeds a set third reference value, based on the number of new subscribers and the affiliation information of the new subscribers.

To this end, the license management unit 210 may select information about the connection patterns of the local terminals 102 corresponding to the affiliation information of the new subscribers among the information about the connection patterns learned by in the pattern learning unit 206. As an example, assuming that the affiliation information of the new subscribers is Company #1/development team approximately 5 people, Company #1/human resources team approximately 5 people, the license management unit 210 may select information about connection patterns of the local terminals 102 corresponding to Company #1/development team and Company #1/human resources team among the information about the connection pattern learned by the pattern learning unit 206. In this case, the information about the connection pattern may include the number of connection times, connection time zone, and connection maintenance time to the first operation mode of the local terminals 102 corresponding to the affiliation information of the new subscriber, the number of times of switching and switching time zone to the second operation mode in the mode switching unit 204, etc.

After that, the license management unit 210 may predict the maximum number of simultaneous connections of the local terminals 102 for the first operation mode for a set period in the future and the time point exceeding a reference value at which it is determined that the maximum number of simultaneous connections exceeds a set third reference value using the information on the selected connection pattern and the number of new subscribers. As an example, the license management unit 210 may predict the maximum number of simultaneous connections for the next 3 months and the time point exceeding a reference value (e.g., approximately 2 months from now) at which the maximum number of simultaneous connections exceeds a third reference value, which is approximately 300 people, from the connection pattern and new subscriber status information (e.g., Company #1/development team approximately 5 people, Company #1/human resources team approximately 5 people) of the local terminals 102 corresponding to Company #1/development team and Company #1/human resources team of the previous example. The license management unit 210 may calculate the maximum number of concurrent connections of the local terminals 102 for the first operation mode during a set period in the future based on past learning data of the local terminals 102 corresponding to the new subscriber status information and predicts the maximum number of simultaneous connections for each period (e.g., on a weekly basis), and predict the time point exceeding reference value at which it is determined that the maximum number of simultaneous connections exceeds the third reference value based on an increase/decrease trend of the maximum number of simultaneous connections.

In addition, the license management unit 210 calculates an additional purchase time point and the number of additional purchases of the licenses for the first operation mode based on the predicted maximum number of simultaneous connections and the time point exceeding the reference value. As an example, the license management unit 210 may determine the additional purchase time point of the licenses for the first operation mode as the time point after approximately 50 days from the present and determine the number of additional purchases as approximately 50 licenses based on the predicted maximum number of simultaneous connections and the time point exceeding the reference value.

As described above, according to embodiments of the present disclosure, by calculating the additional purchase time point and the number of additional purchases of licenses based on the connection patterns of local terminals 120 for the first operation mode, the number of new subscribers of cloud storage and affiliation information of the new subscribers, even if the number of users of cloud storage changes according to the change in time flow, the additional purchase time point and the number of additional purchases of licenses can be accurately predicted in advance, and accordingly the licenses can be managed more efficiently.

If it is determined, as a result of prediction by the license management unit 210, that the maximum number of simultaneous connections of the local terminals for the first operation mode will not exceed the third reference value for a set period in the future, the license management unit 210 may establish a license management strategy such as maintaining or reducing the current number of licenses. The license management unit 210 may transmit a notification message about a license management strategy such as additional purchase, maintenance, and reduction of licenses to an administrator terminal (not illustrated).

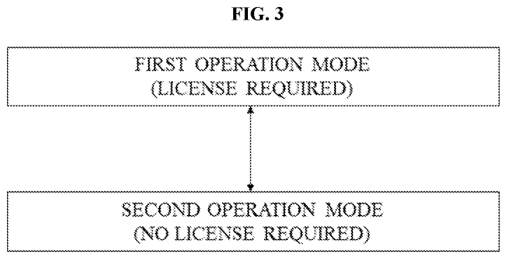

FIG. 3 is a diagram illustrating an example of the first operation mode and the second operation mode in accordance with the exemplary embodiment of the present disclosure.

Referring to FIG. 3, the first operation mode may represent an editing mode and the second operation mode may represent a reading mode. Here, while a license is required for use of the first operation mode, the license may not be required for use of the second operation mode. Meanwhile, the first operation mode and the second operation mode are sufficient if the range of use rights of users is set to be different in using the functions of the third-party application, and the types of the first operation mode and the second operation mode are specifically limited.

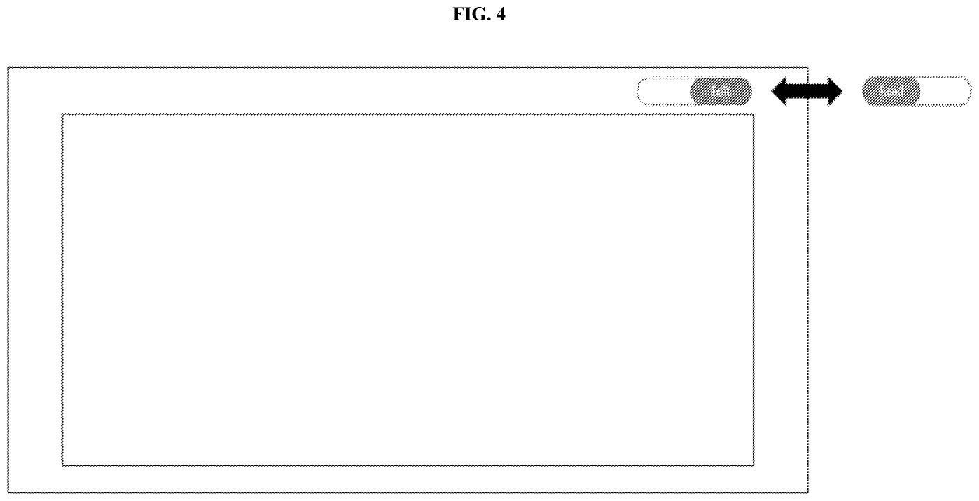

FIG. 4 is a diagram illustrating an example of a user interface for switching between the first operation mode and the second operation mode in accordance with the exemplary embodiment of the present disclosure. Here, the first operation mode may represent an editing mode, and the second operation mode may represent a reading mode.

Referring to FIG. 4, the user interface for switching between the first operation mode and the second operation mode may be formed in the form of a toggle switch, for example. The user can switch from the first operation mode to the second operation mode or from the second operation mode to the first operation mode by using the toggle switch. In this case, when the user switches from the second operation mode to the first operation mode through the toggle switch, the time point of switching to the first operation mode may be the time point of logging into the first operation mode described above.

As mentioned above, the mode switching unit 204 may determine the local terminal 102 not currently using the first operation mode among the local terminals 102 connected to the third-party application in the first operation mode, and automatically switch the first operation mode to the second operation mode for the local terminal 102 of which the time of not using the first operation mode exceeds a threshold value.

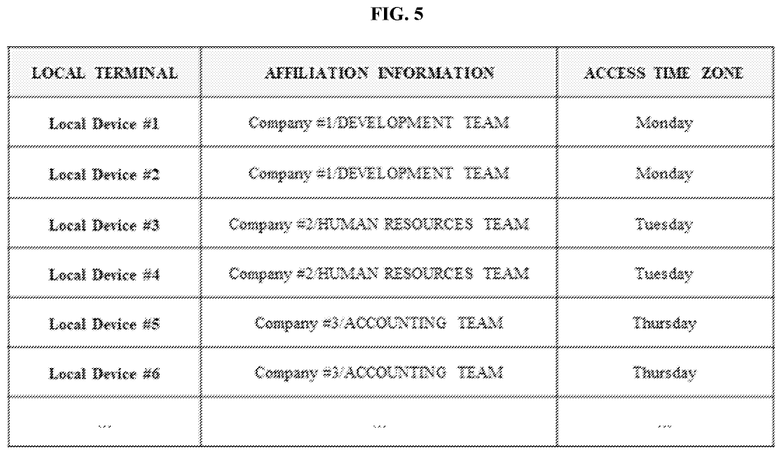

FIG. 5 is a table illustrating an example of a connection status in which connection to the third-party application is made in the first operation mode in accordance with the exemplary embodiment of the present disclosure. As described above, the monitoring unit 202 may monitor, in a state where a set number of licenses for the first operation mode of the third-party application are purchased from the third-party application server 106, the connection status in which connection to the third-party application is made in the first operation mode through the licenses of the local terminals 102 connected to the cloud storage in real time.

Referring to FIG. 5, the monitoring unit 202 may monitor the connection status such as identification information of the local terminal 102 connected to the third-party application in the first operation mode, affiliation information of the user corresponding to the local terminal 102 (e.g., the user's affiliation/position/duty, etc.), connection time zone of the third-party application through the first operation mode of the local terminal 102 (e.g., access days such as Monday/Tuesday, access months such as January/February, etc.), etc. This connection status can be used, by the mode switching unit 204, as reference information for switching the operation mode of the local terminal 102 from the first operation mode to the second operation mode or used to learn, by the license management unit 210, connection patterns of the local terminals 102 for the first operation mode.

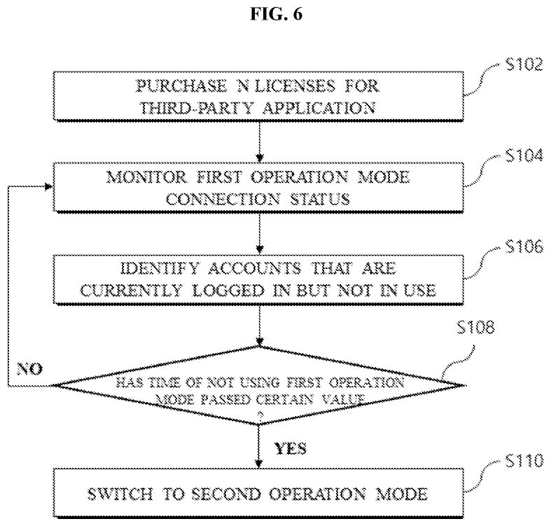

FIG. 6 is a flowchart for describing a method of switching an operation mode of the third-party application in accordance with the exemplary embodiment of the present disclosure. In the illustrated flowchart, the method is described by dividing the method into a plurality of steps, but at least some of the steps may be performed in a different order, may be performed in combination with other steps, may be omitted, may be performed by being divided into detailed steps, or may be performed by being added with one or more steps (not illustrated).

In steps S102 and S104, the monitoring unit 202 monitors, in a state where N licenses for the first operation mode of the third-party application are purchased, a connection status in which connection to the third-party application is made in the first operation mode through the licenses of the local terminals 102 connected to the cloud storage in real time.

In step S106, the mode switching unit 204 determines the local terminal 102 that is not currently using the first operation mode among the local terminals connected to the third-party application in the first operation mode.

In steps S108 and S110, the mode switching unit 204 switches the first operation mode to a second operation mode in which a range of use rights of the third-party application is reduced compared to the first operation mode for the local terminal 102 of which the time of not using the first operation mode exceeds a threshold value (e.g., approximately 30 minutes) among the local terminals determined not to be using the first operation mode.

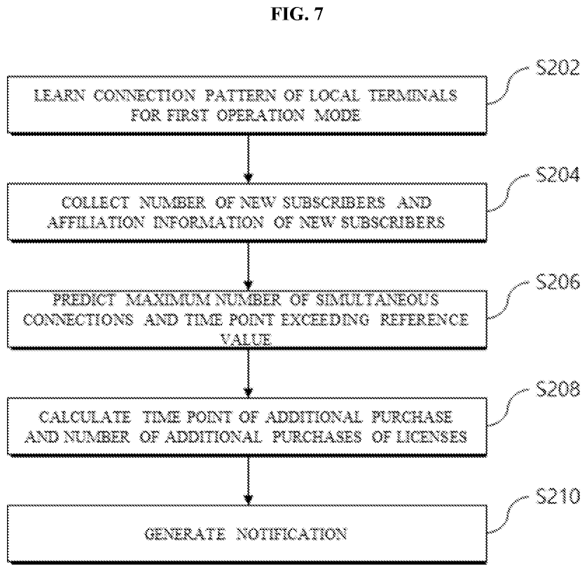

FIG. 7 is a flowchart for describing a method of predicting the time point of additional purchase and the number of additional purchases of licenses in accordance with the exemplary embodiment of the present disclosure. In the illustrated flowchart, the method is described by dividing the method into a plurality of steps, but at least some of the steps may be performed in a different order, may be performed in combination with other steps, may be omitted, may be performed by being divided into detailed steps, or may be performed by being added with one or more steps (not illustrated).

In step S202, the pattern learning unit 206 learns the connection pattern of the local terminals 102 for the first operation mode for a set period from the connection status in which connection to the third-party application is made in the first operation mode through the licenses.

In step S204, the information collection unit 208 collects the number of new subscribers of the cloud storage and affiliation information of the new subscribers.

In step S206, the license management unit 210 predicts, as a result of an analysis of the connection pattern, the maximum number of simultaneous connections of the local terminals 102 in the first operation mode for a set period in the future and a time point exceeding a reference value at which it is determined that the maximum number of simultaneous connections exceeds a set third reference value, based on the number of new subscribers and the affiliation information of the new subscribers.

In step S208, the license management unit 210 calculates the time point of additional purchase and the number of additional purchases of the licenses for the first operation mode based on the predicted maximum number of simultaneous connections and the time point exceeding the reference value.

In step S210, the license management unit 210 transmits a notification message about a management strategy including the time point of additional purchase and the number of additional purchases of the licenses to the administer terminal.

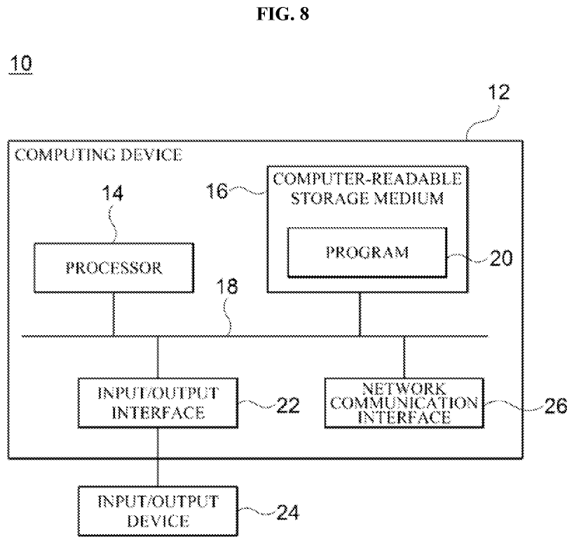

FIG. 8 is a block diagram for illustratively describing a computing environment including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be the third-party application license management system 100 or one or more components included in the third-party application license management system 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although the present disclosure has been described in detail through representative examples above, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

According to embodiments of the present disclosure, a limited number of licenses can be more efficiently distributed and managed by automatically switching an operation mode of a local terminal, which is currently connected to a third-party application in a first operation mode, but is determined not to be currently using the third-party application because there is no input or file change through the first operation mode, from the first operation mode to the second operation mode.

In addition, according to embodiments of the present disclosure, a priority can be assigned to each of the plurality of local terminals in consideration of user's affiliation information corresponding to the local terminal, a non-input duration of the local terminal in the first operation mode, a usage pattern for the first operation mode of the local terminal during a set time in the past, etc. and local terminals that urgently need to switch from the first operation mode to the second operation mode can be sequentially switched to the second operation mode first according to the priority.

In addition, according to embodiments of the present disclosure, by calculating the time point of additional purchase and the number of additional purchases of licenses based on the connection pattern of local terminals for the first operation mode, the number of new cloud storage subscribers, and the affiliation information of the new subscribers, even if the number of cloud storage users changes according to the change in time flow, the time point of additional purchase and number of additional purchases of licenses can be accurately predicted in advance, and accordingly, the licenses can be managed more efficiently.

Although the method for managing license of the third-party application and the cloud server for executing the same have been described with reference to the specific embodiments, they are not limited thereto. Therefore, it will be readily understood by those skilled in the art that various modifications and changes can be made thereto without departing from the spirit and scope of the present disclosure defined by the appended claims.

What is claimed is:

1. A cloud server comprising:
a monitoring unit configured to monitor, in a state where a set number of licenses for a first operation mode of a third-party application are purchased from a third-party application server, a connection status in which connection to the third-party application is made in the first operation mode through the licenses of local terminals connected to the cloud storage in real time; and
a mode switching unit configured to determine a local terminal not currently using the first operation mode among local terminals connected to the third-party application in the first operation mode and switch the first operation mode to a second operation mode in which a range of use rights of the third-party application is reduced compared to the first operation mode for a local terminal of which the time of not using the first operation mode exceeds a threshold value among the local terminals determined not to be using the first operation mode,
wherein the mode switching unit is configured to distribute the set number of licenses to local terminals that do not have use rights of the first operation mode free of charge when the number of local terminals connected in the first operation mode through the license is equal to or less than a first reference value, and switch the first operation mode to the second operation mode for the local terminals to which the license is distributed free of charge when the number of local terminals connected in the first operation mode through the license exceeds a second reference value.

2. The cloud server of claim 1, wherein the time of not using the first operation mode is a duration during which no input or file change is made on the third-party application from a time point of logging in to the first operation mode in the local terminal or a time point of refreshing a screen of the first operation mode in the local terminal.

3. The cloud server of claim 1, wherein the mode switching unit, when a plurality of local terminals of which the time of not using the first operation mode exceeds the threshold value are present among the local terminals determined not to be using the first operation mode, is configured to assign a priority to each of the plurality of local terminals in consideration of at least one of user's affiliation information corresponding to the local terminal, a non-input duration of the local terminal in the first operation mode, and a usage pattern for the first operation mode of the local terminal during a set time in the past, and sequentially perform switching to the second operation mode for each of the plurality of local terminals according to the priority.

4. The cloud server of claim 1, further comprising:
a pattern learning unit configured to learn a connection pattern of local terminals for the first operation mode for a set period from the connection status in which connection to the third-party application is made in the first operation mode through the license;
an information collection unit configured to collect the number of new subscribers of the cloud storage and affiliation information of the new subscribers; and
a license management unit configured to predict, as a result of an analysis of the connection pattern, the maximum number of simultaneous connections of the local terminals for the first operation mode for a set period in the future and a time point exceeding a reference value at which it is determined that the maximum number of simultaneous connections exceeds a set third reference value, based on the number of new subscribers and the affiliation information of the new subscribers, and calculate an additional purchase time point and the number of additional purchases of the licenses for the first operation mode based on the predicted maximum number of simultaneous connections and the time point exceeding the reference value.

5. The cloud server of claim 4, wherein the license management unit is configured to select information on the connection pattern of local terminals corresponding to the affiliation information of the new subscriber among pieces of information on the connection pattern learned by the pattern learning unit, and predict, using the selected information on the connection pattern and the number of new subscribers, the maximum number of simultaneous connections of the local terminals for the first operation mode for a set period in the future and the time point exceeding a reference value at which it is determined that the maximum number of simultaneous connections exceeds the set third reference value.

6. A method for managing a license of a third-party application performed in a cloud server for which a set number of licenses for a first operation mode of the third-party application are purchased from a third-party application server, the method comprising:
monitoring, by a monitoring unit, a connection status in which connection to the third-party application is made in the first operation mode through the licenses of local terminals connected to the cloud storage in real time;
determining, by a mode switching unit, a local terminal not currently using the first operation mode among local terminals connected to the third-party application in the first operation mode; and
switching, by the mode switching unit, the first operation mode to a second operation mode in which a range of use rights of the third-party application is reduced compared to the first operation mode for a local terminal of which the time of not using the first operation mode exceeds a threshold value among the local terminals determined not to be using the first operation mode,
wherein the method further comprises, after the monitoring of the connection status in which connection to the third-party application is made in the first operation mode in real time:
distributing, by the mode switching unit, the set number of licenses to local terminals that do not have the use rights of the first operation mode free of charge when the number of local terminals connected in the first operation mode through the license is equal to or less than a first reference value; and
switching, by the mode switching unit, the first operation mode to the second operation mode for the local terminals to which the license is distributed free of charge when the number of local terminals connected in the first operation mode through the license exceeds a second reference value.

7. The method of claim 6, wherein the time of not using the first operation mode is a duration during which no input or file change is made on the third-party application from a time point of logging in to the first operation mode in the local terminal or a time point of refreshing a screen of the first operation mode in the local terminal.

8. The method of claim 6, wherein, in the switching of the first operation mode to the second operation mode, when a plurality of local terminals of which the time of not using the first operation mode exceeds the threshold value are present among the local terminals determined not to be using the first operation mode, a priority is assigned to each of the plurality of local terminals in consideration of at least one of user's affiliation information corresponding to the local terminal, a non-input duration of the local terminal in the first operation mode, and a usage pattern for the first operation mode of the local terminal during a set time in the past, and switching to the second operation mode is sequentially performed for each of the plurality of local terminals according to the priority.

9. The method of claim 6, further comprising, after the monitoring of the connection status in which connection to the third-party application is made in the first operation mode in real time:
learning, by a pattern learning unit, a connection pattern of local terminals for the first operation mode for a set period from the connection status in which connection to the third-party application is made in the first operation mode through the license;
collecting, by an information collection unit, the number of new subscribers of the cloud storage and affiliation information of the new subscribers;
predicting, by a license management unit, as a result of an analysis of the connection pattern, the maximum number of simultaneous connections of local terminals for the first operation mode for a set period in the future and a time point exceeding a reference value at which it is determined that the maximum number of simultaneous connections exceeds a set third reference value, based on the number of new subscribers and the affiliation information of the new subscribers; and
calculating, by the license management unit, an additional purchase time point and the number of additional purchases of the licenses for the first operation mode based on the predicted maximum number of simultaneous connections and the time point exceeding the reference value.

10. The method of claim 9, wherein, in the predicting of the time point exceeding the reference value, information on the connection pattern of local terminals corresponding to the affiliation information of the new subscriber is selected among pieces of information on the connection pattern learned by the pattern learning unit, and the maximum number of simultaneous connections of local terminals for the first operation mode for a set period in the future and the time point exceeding a reference value at which it is determined that the maximum number of simultaneous connections exceeds the set third reference value is predicted using the selected information on the connection pattern and the number of new subscribers.
